(19) United States
(12) Patent Application Publication
(10) Pub. No.: US 2002/0113096 A1
(43) Pub. Date: Aug. 22, 2002

(54) TWIST-STYLE DISPENSING CLOSURE WITH VENTING SYSTEM

(76) Inventor: JOSEPH P. VALLEY III, LANCASTER, NJ (US)

Correspondence Address: Shahan Islam, Rosenman & Colin LLP, 575 Madison Avenue, New York, NY, 10022-2585, US

(21) Appl. No.: 09/386,091

(22) Filed: Aug. 13, 1999

(51) Int. Cl. B67D 3/00; B65D 51/16

(52) U.S. Cl. 222/521; 215/307; 222/525

(57) ABSTRACT

A closure assembly for a container containing substantially flowable contents generally comprises a closure cap, a sealing peg having a flat portion such that a small orifice is created between the cap and the sealing peg which remains slightly open when the closure is in a closed position.

### CROSS-REFERENCE TO RELATED APPLICATION

This is a non-provisional utility application counterpart to U.S. Provisional Application No. 60/096,510, filed Aug. 13, 1998.

### FIELD OF THE INVENTION

The present invention relates generally to closures for dispensers and more particularly to a twist-style dispensing closure with a venting system.

### BACKGROUND OF THE INVENTION

In the food packaging industries, even the appearance of defects on packaging can render goods unsaleable, whether or not there is any harm or danger to the food product itself.

One example of the appearance of defects is the common problem known as paneling. The problem occurs, for instance, when a plastic (or other flexible) bottle is filled with a product which has been heated for pasteurization or for other reasons. After a dispenser bottle has been filled, a vacuum is created inside the bottle as it cools, causing it to collapse inwardly. One corrective action for this situation involves the process of filling the empty space between the product and closure with nitrogen gas. Such a solution is costly and as it involves additional material and another step in the package filling process.

It is therefore an object of the present invention to provide an economical solution to the paneling problem.

### SUMMARY OF THE INVENTION

This and other objects of the invention, which shall be hereafter apparent, is achieved by the a Twist-Style Dispensing Closure with Venting System having an irregularly-shaped sealing peg on the closure assembly, thereby creating a small void in the sealing surface between the peg and a closure cap of the dispensing closure. This void is large enough to allow air to enter the bottle as the product cools, however, it is too small to allow the product to be dispensed without opening the closure.

### BRIEF DESCRIPTION OF THE DRAWINGS

The invention will be better understood by the Detailed Description of the Preferred Embodiment, with reference to the drawings, in which:

FIG. 1 is a partially cut-out, cross sectional view of the Twist-Style Dispensing Closure with Venting System;

FIG. 2 is a detailed cross-sectional view of the dispenser closure showing an orifice vent between the sealing peg and the closure cap; and

FIG. 3 is a not to scale plan view of the closure showing an orifice between the sealing peg and cap when closure is in a closed position.

### DETAILED DESCRIPTION OF THE PREFERRED EMBODIMENT

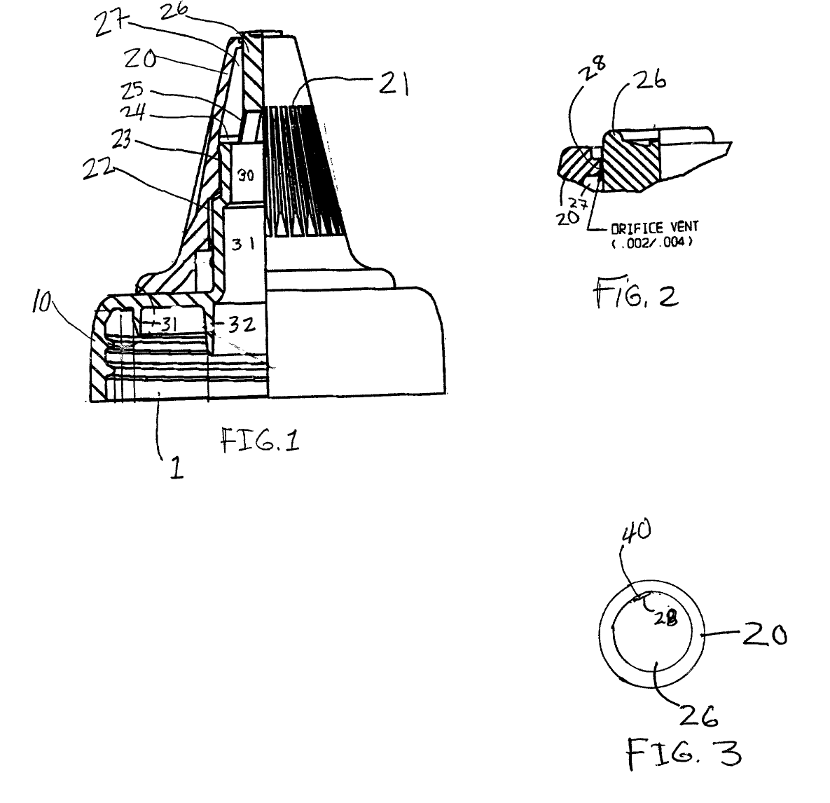

Referring now to the drawings, wherein like numerals reflect like elements throughout the various views, FIG. 1 shows generally a container 1 having generally a base closure 10 and a cover cap 20.

The cover cap 20 preferably has serrations 21 for ease of gripping for rotation thereof around a post comprised of a number of segments and projecting generally upward. The cover cap 20 has lugs which ride on cams of lower segment 22 of the post to lift and lower the cap 20 between the open and closed positions. The post generally comprises a lower 22 cylindrical shaped segment, middle segment 23, connecting horizontal segment 24, angular connecting segments 25, with apertures which allow the contents of the container to flow therethrough, and sealing peg 26.

FIG. 2 shows the sealing peg 26 in further detail. Between the sealing peg 26 and the cover cap 20 is air space 27 (see FIG. 1) which is part of the dispensing area and is in communication with dispensing channels 30, 31. The sealing peg 26 has a flat portion 28 such that when the cap is in the closed position, an aperture 40 remains. The flat portion 28 is created by a complementary flat portion on a melding element.

This is best shown in FIG. 3, which depicts, from above, the cover circumscribing the sealing peg. An aperture 40 remains because the flat portion 28 renders the outer surface of the sealing peg 26 not fully complementary with the inner surface of the cover cap 20. For a mustard container, for instance, it has been found that an aperture between 0.002-0.004 inch is preferable.

While the preferred embodiment of the invention is depicted in detail, modifications and adaptations may be made thereto, without departing from the spirit and scope of the invention as delineated in the following claims:

What is claimed is:

1. A closure assembly for a container containing substantially flowable contents therein, said assembly comprising:
a closure cap;
a sealing member; and
a small orifice between the cap and the sealing member which remains slightly open when the closure is in a closed position.

2. The closure assembly of claim 1, wherein said orifice is created by a non-uniformity configuration on the sealing member.

3. The closure assembly of claim 2, wherein said configuration is a substantially flat portion.

4. The closure assembly of claim 3, wherein said aperture has a maximum width of between about 0.001-0.008 inch.

5. The closure assembly of claim 4, wherein said aperture has a maximum width of between about 0.002-0.004 inch.

6. A method of making a closure assembly for a container containing substantially flowable contents therein, said method providing the steps of:
providing a sealing member;
rotatably securing a closure cap around said sealing member; and
providing a small orifice between the cap and the sealing member, wherein said orifice remains slightly open when the closure is in a closed position.

7. The method of claim 1, wherein said orifice is created by a non-uniformity configuration on the sealing member.

8. The method of claim 7, wherein said configuration is a substantially flat portion.

9. The method of claim 8, wherein said aperture has a maximum width of between about 0.001-0.008 inch.

10. The method of claim 9, wherein said aperture has a maximum width of between about 0.002-0.004 inch.
